(19) United States
(12) Patent Application Publication
(10) Pub. No.: US 2025/0258053 A1
(43) Pub. Date: Aug. 14, 2025

(54) INDUCTIVE THUMB STICK

(71) Applicant: AZOTEQ HOLDINGS LIMITED, Nicosia (CY)

(72) Inventor: Frederick Johannes BRUWER, Paarl (ZA)

(21) Appl. No.: 19/044,690

(22) Filed: Feb. 4, 2025

(30) Foreign Application Priority Data
Feb. 12, 2024 (ZA) 2024/01290

(51) Int. Cl. G01L 5/22; G01L 1/12; G01L 5/164; G06F 3/01

(52) U.S. Cl. CPC G01L 5/223; G01L 1/127; G01L 5/164; G06F 3/016

(57) ABSTRACT

A thumb stick arrangement and a method of operating said arrangement that involves minimal moving parts and reduced friction near a zero position. Use is made of force sensors, and specifically of inductive force sensing methods. Additionally, rotation of a force lever can be measured using Hall or TMR sensing techniques to add more user interface options.

### CROSS-REFERENCE TO RELATED APPLICATION

The present application claims the benefit of South African Provisional Patent Application No. 2024/01290, filed on Feb. 12, 2024, the content of which is hereby incorporated by reference into this application.

### BACKGROUND

The use of thumb sticks (TS) or joy sticks is ubiquitous in today's world. Thumb sticks are found in consumer products such as gaming and drone controllers but also in industrial products such as cranes, forklifts and airplanes.

The construction of a state of the art unit is quite complex with many moving parts. This results in reliability issues due to wear and tear as well as “drift” near a zero/neutral point due to friction or other reasons.

### SUMMARY OF THE INVENTION

It is an objective of the invention to provide a cost effective, accurate system with few moving parts and good long term reliability.

Exemplary systems described herein are only for clarification and are not to be seen as limiting the scope of the invention.

In accordance with the invention described herein a range of solutions can be envisaged with almost no user interface lever movement experienced by the user, for use in systems with movements similar to what is experienced in state of the art thumb sticks but with fewer or no moving parts.

It is especially important that close to the zero/neutral point i.e. the position where the lever comes to rest when nothing is in contact with the TS, there is little or no friction between parts, and no gears are engaged with less or no moving contact between parts. It is also important that the measurements in the thumb sticks require no ohmic contact.

In a first embodiment a flat rigid layer or layer member is constructed with four spaced apart force sensors positioned at corners of the rigid layer. This may be incorporated in a module. The sensors may, for example, be inductive force sensors. The inductive measurements (for each force sensor) are influenced by displacement of an (inductive) interfering member (metal or ferrite) that moves closer to or away from an inductor (for example a flat pcb coil), that is measured, or into and out of a core of an inductor that is measured. An electrically conductive metal interfering member will reduce the inductance as it is moved closer to a coil, while a ferrite will increase the inductance of the affected coil; similarly for an interfering member moving into the core of an inductor. A combination of conductive metal and ferrite may also be used to achieve a bigger change in inductance.

The sensors may be under the rigid layer, e.g. in direct or indirect engagement with the underside thereof.

If a rigid lever is firmly attached perpendicularly to a center of said rigid layer the force sensing measurements from the combination of force sensors can be used to resolve the amount (magnitude) of the pressure (or force) and the direction of the pressure (or force) applied to the perpendicular lever.

“Pressure” and “force” are used interchangeably herein.

The rigidity of both the flat layer and the perpendicular lever will determine the amount of movement resulting from the user pressure. Since the force sensors' resolution is such that micrometers or less displacement can be detected and measured, it is possible to make the movement of the lever not perceivable or with a very small displacement compared to that of a standard joystick. Each sensor is thus responsive to displacement of the layer at the location of the sensor.

A push button switch or a dome switch may be mounted under the center of the rigid layer and, if the layer is flexible enough, a central downward pressure will activate the switch. A rod located down a center shaft may alternatively be used (similar to functions in state of the art TS products). When using the force sensor measurements the switch function may be ignored if the pressure is not mostly directly downwards in the middle of the layer.

The thumb stick module may include blocking structures to prevent excessive force being applied to the switch or to the sensors.

Even without a physical switch in the middle, the switch function can be implemented using the force sensors measurements. If enough pressure is detected and if the force is evenly spread between the four (or other number of) force sensors, it means the pressure is a downwards pressure, as is required by conventional joystick products, for activating a click switch function. Haptics can be used to provide feedback similar to the push button switch or dome switch tactile “click”.

With a more flexible flat (or typically horizontal) layer and by suitably shaping of the layer, the lever can physically move under user actuation. This can be designed to be similar to what is experienced in state of the art joystick products.

Again, blocking structures can protect the lever of the joystick, designed in accordance with this invention, from being moved beyond certain boundaries.

The lever can be flexible to a degree that will allow the required bending so that, even with a more rigid horizontal layer, a perception of movement of the lever is given to the user. This means for maximum designed pressure, the perpendicular lever will bend to the point where it will be blocked by the blocking structures. For example, the blocking structure will allow for a bend of 25 degrees from the perpendicular.

As can be understood from this summary there is no rotational movement around two orthogonal axes as is found in most conventional joystick products.

Haptic feedback may be used to indicate movement to the user, although no or very little physical movement may occur. The displacement or movement affecting the force sensing measurements at the ends of the rigid layer or layer member, where the force sensors are positioned, may be at least 5 times less than the movement of the force transfer lever top in implementations where the system is designed to mimic the movement of the force transfer levers in state of the art thumb sticks (i.e. less than one-fifth of such movement).

With a Hall effect sensor placed in the center below the lever, horizontal rotation of the force transfer lever can be detected and measured if a magnet is attached to the bottom of the lever and the attachment of the lever is such that rotation is possible.

An example of an application of the horizontal rotation of the force lever can be when the user demands very fine and accurate movements, for a gain factor can be adjusted to make this easier. The force lever may be fitted with a dial and the necessary descriptions of the functions that can be associated with different horizontal rotated angles can be printed on the thumb stick housing, for example.

In another embodiment the module is designed to allow movement of the center force transfer lever in any direction under force applied by a user. Due to the larger displacement of the interfering members at the inductive coils used for measuring displacement/force, a method of moving the interfering member into and out of the cores of the respective measurement inductive coils is proposed.

The invention in general is based on the use of a rigid layer with force sensors to measure force applied to a force transfer lever that turns horizontal pressure through rotation of the lever around a pivot point into pressure on the rigid layer that is then measured by the force sensors. Inductive sensing is particularly well suited to perform the force sensing but certainly is not the only technique. The force sensors may be utilize other technology such as, for example, strain gauges or piezo elements.

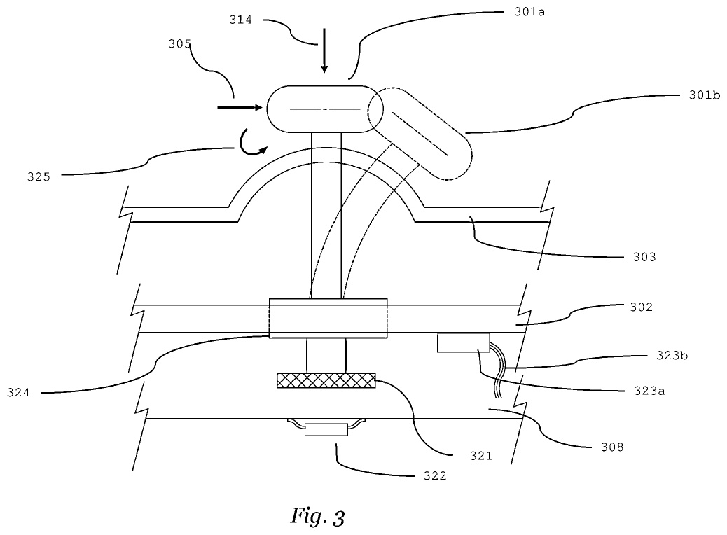

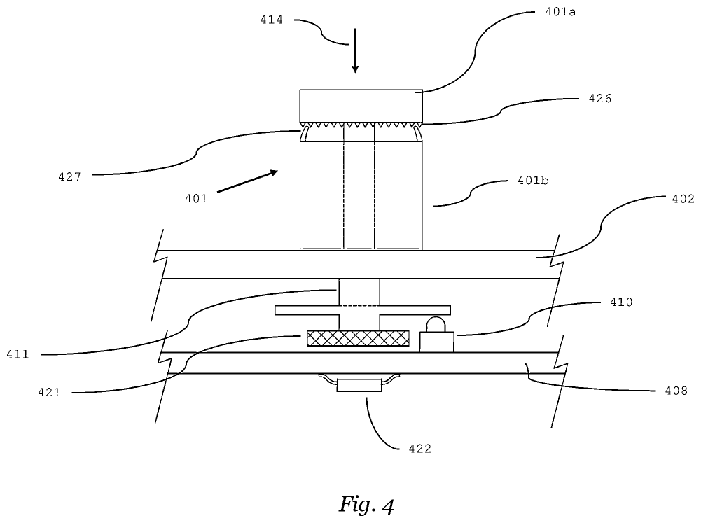

A significant shortcoming in state of the art traditional thumb sticks is found in that “stick drift” often become a problem over time. The design in accordance with this invention is advantageous in that friction between parts can be minimized at the zero position. In an embodiment of this invention any downwards force (see FIG. 4—414, FIG. 3—314) (even just a touch) can be detected by the force sensors. This touch/no touch information deduced from the inductive force sensors can be used to constantly calibrate the zero position parameters to avoid and prevent drift around the zero position.

In accordance with this invention the response from the joystick can be manipulated to be weighted towards keeping to the main North/South and East/West axes, i.e. be a little forgiving with slight deviations from the true N/S or E/W direction, but with enough movement (e.g. 5 degrees) the correction will start gradually to be accurate again at an angle of 45 degree.

This is specifically because due to the displacement of the force lever equal forces push back to the zero position in all directions. This is different from what is experienced in traditional joy sticks.

An important concept in the invention is the implementation of a mechanism to turn horizontal force on the force lever (as is normally used to operate a joystick) into a vertical force that is also related to the direction of the horizontal force.

Several exemplary designs are described in more detail below but many other possible implementations are possible in accordance with this invention.

Hall effect is the term used for magnet sensing but TMR sensors or other magnetic field sensing techniques could be used.

In another embodiment the inflexible layer is placed over a pcb with four inductors in respective corners of the pcb, each with an interfering member attached, directly or indirectly, to the inflexible layer. The interfering members move into the cores of the respective inductors when a downward force is exerted onto the inflexible top layer.

A force/pressure exerting member may be attached to the structure with the user interface lever and a housing structure that cause the user interface lever to only move in a flat plane. The force exerting member then slides over the inflexible top layer to cause the point of pressure to move in a way that is related to the movement of the user interface lever.

Springs may return the user interface lever to the center or neutral position if no force is applied by the user. The force/pressure member causing movement across the top layer results in the displacement of the interfering members in the four corners to move into and out of the inductive coils and from the inductive measurements the x, y position of the user interface lever can be determined.

In order to facilitate good differential functionality, the interfering members must extend partly into the cores of the respective measuring inductors when no user force is exerted onto the joystick.

The mechanisms to keep the user interface lever in a flat plane may vary.

The terms “joystick” and “thumb stick” are regarded as equivalent in meaning.

In one embodiment the invention provides a method of operating a thumb stick arrangement which comprises a user interface force transfer lever, a rigid layer member and force sensors at spaced apart locations around the rigid layer member, each force sensor being responsive to displacement of the rigid layer member at the respective location, the method including the steps of using said force transfer lever to transfer a horizontal force applied by a user onto the force transfer lever into a vertical force which is applied onto the rigid layer member, determining measurements of the respective forces which are applied to the force sensors due to said vertical force, and using said force measurements from the sensors to calculate a metric which is related to the magnitude of the user applied horizontal force and a direction of application of the horizontal force.

The invention provides a thumb stick arrangement which comprises a rigid layer member, a force transfer lever which is configured to transfer a horizontal force which is applied by a user onto the force transfer lever into a vertical force which is applied onto the rigid layer member, a plurality of force sensors at spaced apart locations of the rigid layer member each respective sensor producing measurement information of the force applied to the respective force sensor due to said vertical force, and a mechanism for combining said measurement information to calculate a metric related to the magnitude of the user applied horizontal force and a direction of application of the horizontal force.

### BRIEF DESCRIPTION OF THE DIAGRAMS

The invention is further described with reference to the following drawings:

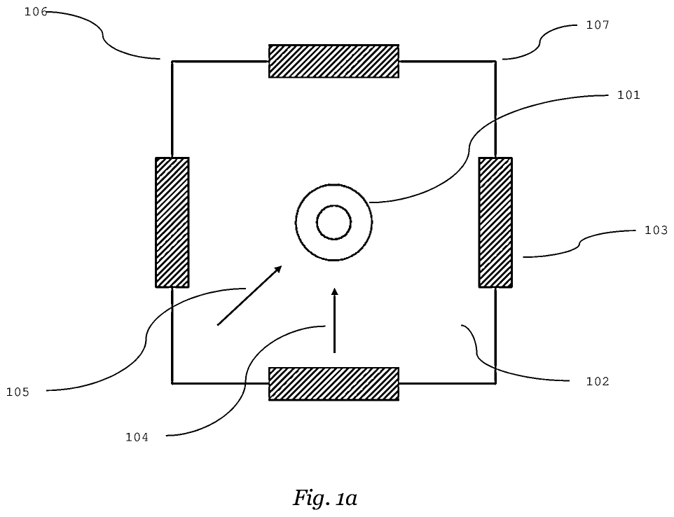

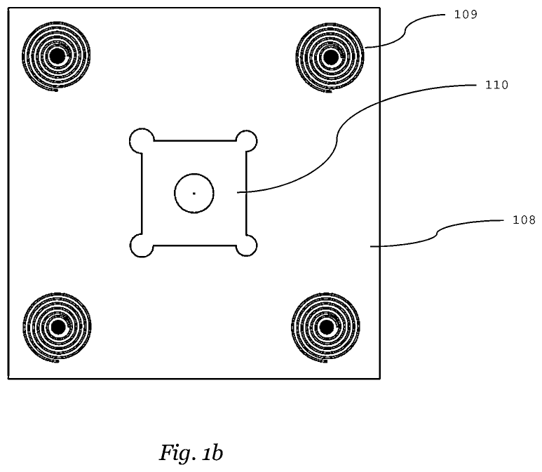

FIG. 1a is a top view of a rigid layer used in a thumb stick according to the invention.

FIG. 1b is a top view of a printed circuit board used in a thumb stick according to the invention.

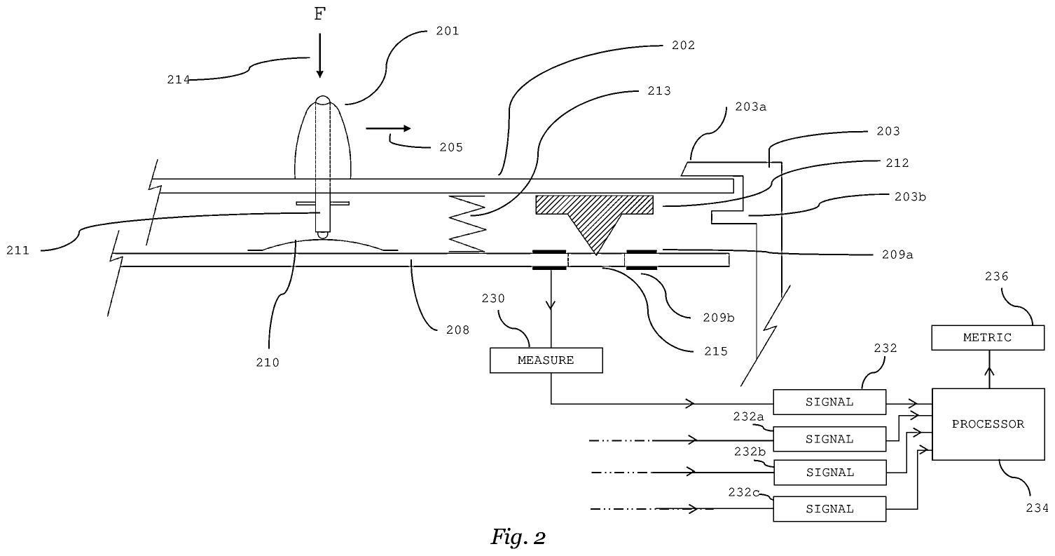

FIG. 2 is a side view showing the construction of a force transfer lever and of an inductive sensor.

FIG. 3 depicts movement of a flexible force lever with horizontal rotation measurements and haptics.

FIG. 4 is a side view of a rigid thumb stick with horizontal rotation measurement and a tactile push button switch.

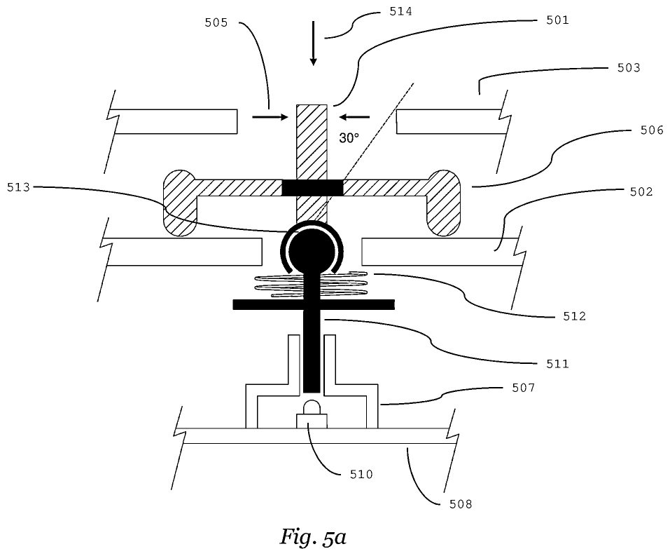

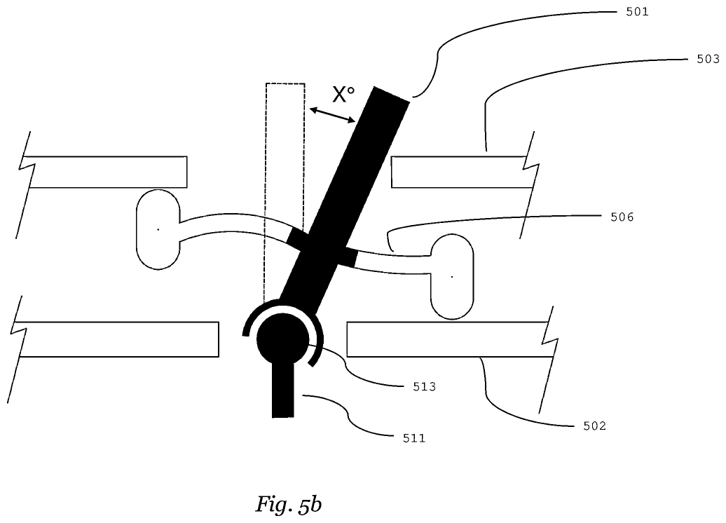

FIG. 5a shows a full movement inductive thumb stick.

FIG. 5b shows a flexible force transfer disc for use in the thumb stick of FIG. 5a.

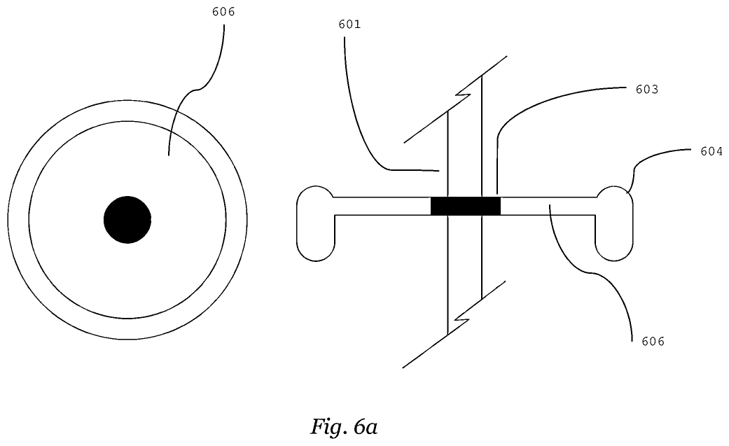

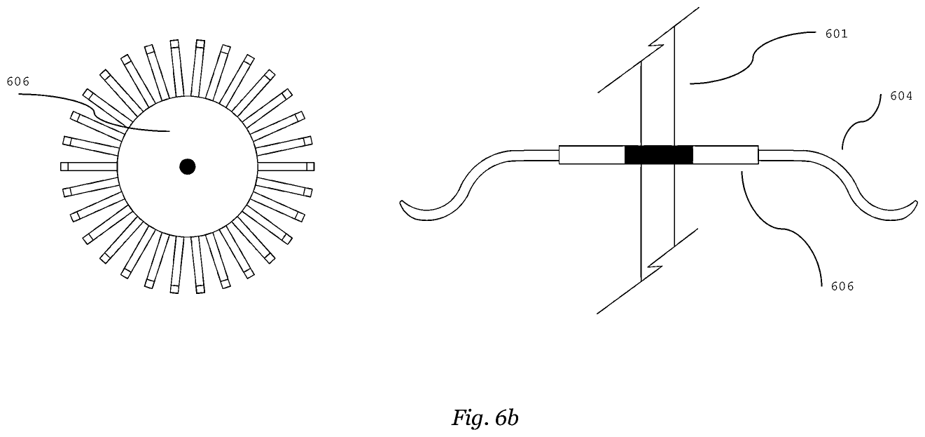

FIG. 6a shows a plan and side view of a solid disc.

FIG. 6b shows a disc with multiple spokes.

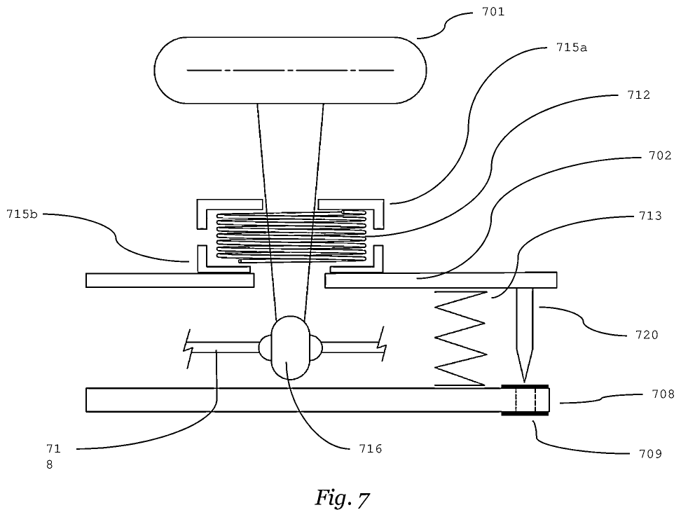

FIG. 7 illustrates a simplified force sensor thumb stick

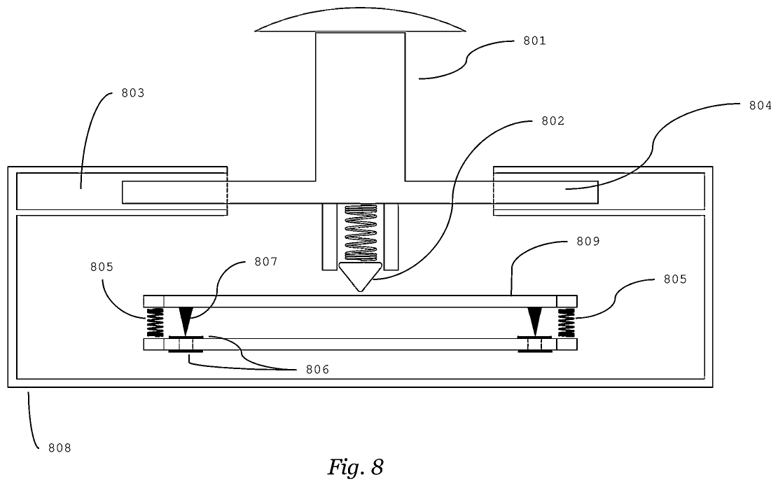

FIG. 8 shows a planar joystick according to the invention.

### DETAILED DESCRIPTION

The following description of the appended drawings is presented merely to clarify the spirit and scope of the present invention, and not to limit such scope. These are embodiments in example applications, and a large number of alternative or equivalent embodiments and applications may exist which will still fall within the scope of the claims of the present invention.

FIG. 1a is a top view of a minimum movement joystick with a square, very rigid horizontal layer (plate) 102 with inductive coils, for example implemented as tracks on a printed circuit board (see FIG. 1b), below the four corners of the square plate. There are blocking structures 103 that form a part of a housing that holds the layer 102 in position and prevent it from lifting in most areas and preventing too much horizontal movement.

The horizontal layer (plate) may be conceptually rotated 90 degrees so that North/South movement and East/West movement will be reflected in measurements of single inductors or two inductors (differential). This may have an impact on the push back force experienced by a user. However, such said 90 degree rotation is different from the way state of the art thumb sticks are positioned.

It is possible to implement the joystick with only two measurement inductors if the interfering members are positioned such that up and down displacement can be accurately measured.

A force transfer lever 101 is orientated perpendicularly to the horizontal layer 102 and when pushed horizontally by a user in any direction (360 deg) the magnitude of the pressure applied and the direction thereof can be derived from force sensing measurements made under the four corners of the rigid layer 102. In this example a very rigid structure is proposed with no relative movement between the lever 101 and the horizontal rigid layer 102.

A force in a direction 104 will create a rotational force that can be measured on the force sensors at the corners 106 and 107. Whereas a force in a direction 105 (north/east) will be measured mostly on the sensor at the corner 107.

However, the direction and level of force or pressure applied by the user will ideally be calculated by using differential information from two or more of the force sensors.

FIG. 1b is a top view of a pcb 108 with inductive coils 109 formed by tracks on the pcb. In the center a dome plate 110 is positioned to form a tactile switch that is activated under downwards pressure, in excess of a predefined minimum level, that is exerted onto the force transfer lever 101, shown in FIG. 1a.

FIG. 2 shows some aspects of the construction of a thumb stick to supplement the structure shown in FIG. 1a and FIG. 1b.

A force transfer lever 201 is attached to a rigid layer 202 and a rod 211 is positioned in a shaft down a center of the force transfer lever 201. A downwards force (F) 214 applied to the rod 211 will result in the snap through of a dome plate 210 to close an ohmic connection and create tactile feedback. The switch function can also be implemented using a push button switch in the dome plate 210. Blockers can be used to limit the pressure that can be applied onto the dome plate or switch 210. The rod 211 can also be a part of the shaft in the lever 201. Enough downward force will cause sufficient downward movement by overcoming the push back force of springs 213, in order to activate the switch 210.

An example of a spring 213 is shown that will push back against the rotation force resulting from a user applied force 205. A housing structure 203 has an upper block 203a and a lower block 203b to restrict movement of the rigid layer 202. This will for example help to prevent damage to the spring 213, and to the sensor elements (coils) 209, comprising 209a and 209b as a single coil or as two separate coils.

An inductive force sensor is implemented using an interfering member 212 that affects the inductance of the coil 209 in relation to the distance between the interfering member 212 and the coil 209a/b, and also in relation to the area of the core 215 of the inductive coil 209 that is filled by the tip of the interfering member 212. It is also possible to use only one of these inductance changing techniques.

Notionally shown in FIG. 2 is a measurement device 230 which measures the change in inductance in the coil 209 caused by movement of the interfering member 212. The inductance of each coil (one at each corner of the layer 202) is similarly measured by corresponding devices (not shown). The device 230 produces a signal 232 which is dependent on the measured change in inductance of the coil. The signal 232 and the corresponding signals marked 232a, 232b and 232c, from the other (not shown) devices are applied to a processor 234 which uses the measurement data to calculate a metric 236 which is related to the magnitude of the horizontal force 205 which produces the downward force 214 and the direction of such horizontal force. Similar techniques, not further described nor shown herein, are used as appropriate in the other embodiments of the invention described herein. The force sensors are configured to distinguish between an in-touch condition and a no-touch condition by a user on the lever 201 and the processor 234 using resulting data from the sensors for calibration of the metric 236 and for correcting the metric to take account of stick (lever) drift.

Movement of the interfering member 212 into the core 215 of the inductive coil 209 can be made very linear over a large range of the degree of tilt of the rigid layer 202.

The effect of a flat interfering member 212 moving closer to the surface of the inductor coil 209a is exponential and results in a large change when closer to the surface but a small change at a distance from the surface, referred to herein as a “surface effect”.

Hence if small displacement is used the combination or the surface effect is proposed. If larger displacements are involved the combination of the movement of the interfering member into the coil core and of the surface effect is proposed, or only the movement of the interfering member into the core of the inductor is suggested.

The description is exemplary and all elements need not be implemented in each product designed in accordance with this invention.

FIG. 3 relates to displacement in relation to a user force which is exerted with the use of horizontal rotation, and the use of haptics as a user feedback mechanism.

A force lever 301 is flexible to the effect that the maximum predefined force to be measured in a direction 305 will bend it from a position 301a to a position 301b. At this angle (say designed for 30 degrees) the lever gets blocked by a housing 303. This holds for all directions. This relates to the maximum sideways/horizontal force that can be turned into a rotational force. Said rotational force effect can be measured by the force sensors as discussed above.

To implement a horizontal rotation measurement the force transfer lever 301 must be fixed to the rigid layer 302 e.g. by using a bush or ball bearing element 324. This will allow a sideway force to be transferred to the rigid layer 302, and will also allow the force transfer lever 301 to be horizontally rotatable as depicted by a curved arrow 325.

The force transfer lever 301 may be extended past the rigid layer 302. A magnet 321 may then be attached to a bottom end of the lever 301. A magnetic (e.g. Hall/TMR effect) sensor 322 mounted on either side of the pcb 308 can determine the orientation of the magnet, and can detect rotation (325) of the force transfer lever 301. The rotational position can be used to adjust gain, select modes or functions and in principle adds another degree of selection to the user interface.

A downwards force 314 can be detected from the combined measurements of all the force sensors. If the user wants to implement a switch function (equivalent to a downward pressure switch activation in state of the art switches) this can be determined when the total downward force 314 reaches a predetermined level.

A haptic signal generator 323a is electrically connected to the pcb 308 with wiring 323b. The haptic signal generator 323a may be an LRA or any other state of the art component and is used to provide user feedback. Feedback may be implemented for some or all functions i.e. horizontal pressure 305, downwards force 314 beyond the predetermined level for switch activation or horizontal rotation 325 of the force transfer lever 301.

The force sensors are not shown in FIG. 3 but can be similar to the implementation described in connection with FIG. 2. It is also possible to use only two inductive sensors to resolve horizontal force magnitude and direction.

The thumb stick shown in FIG. 4 offers a minimal displacement of a force lever 401 for sideways pressure exerted by the user, features horizontal rotation measurement using a magnet 421 and a Hall effect sensor IC 422 and a downwards pressure push button switch 410 with tactile feedback.

The force lever 401 transfers horizontal user pressure into a downwards force on the rigid layer 402 that can be measured by the force sensors as described in connection with FIG. 2, or with other force sensors.

A top part 401a of the force transfer lever 401 is rotatable in relation to a bottom part 401b. The top part 401a is attached to a rod 411 that is fitted through a shaft in the center of the bottom part 401b.

Springs 427 and a surface pattern 426 can be used to create a ratchet feedback effect as the top part 401a is rotated. A magnet 421 is attached to the end of the rod 411. Rotation of the magnet can be determined by using a Hall effect sensor 422 or another rotational magnetic sensing implementation.

Downward pressure on the force lever part 401a will result in downwards force on a switch 410 until the switch is activated. The switch activation can be measured by a controller (not shown) on the pcb.

If horizontal rotation measurements are not required the magnet can be removed and the switch 410 can be positioned in the middle underneath the rod 411.

FIG. 5a shows a different embodiment using a rigid layer 502 (similar to the layer 402) and sensors (not shown but optionally as per the description relating to FIG. 2). The construction provides for displacement of a force transfer lever 501 under pressure by a user (similar to state of the art thumb sticks).

However instead of the force transfer lever 501 directly converting horizontal pressure into downward pressure on the force sensors (as per the FIG. 2 example) the force is converted through a flexible disc 506. The disc 506 may take on different forms as is shown for example in FIGS. 6a and 6b.

As more horizontal pressure (e.g. 505) is applied the more the disc 506 is deformed. This is the same for any direction of the pressure. The system must be designed so that the disc is not pushed past its plasticity point in order to avoid permanent deformation. The return to zero is a natural reset where friction is low because of tension in the various elements, for example in the rotation joint 513 and in a spring 512.

The disc 506 can be metal (e.g. spring steel), rubber, plastic, carbon fiber etc.

If the downward force 514 is sufficiently large the disc 506 is deformed. Also the back pressure from the spring 512 and the switch 510 is overcome and the switch 510 is activated.

A structure 507 creates a guide for a rod 511 and prevents the force transfer lever 501 from applying excessive force on the switch 510 via the rod 511. The spring 512 keeps the structure intact.

In FIG. 5b the force transfer lever 501 is pushed to a maximum extent and is blocked by the housing 503 from further horizontal movement. The deforming of the disc 506 is shown in concept. The further the lever 501 is pushed the greater is the downwards pressure exerted by the disc 506 on the rigid layer 502.

The horizontal rotation of the force sensing lever 501 and the measurement using a magnet and Hall sensing can be done in accordance with the processes described in connection with FIGS. 3 and 4.

The design of the disc 506 can take many forms and in FIGS. 6a and 6b two exemplary designs (606) are shown. In FIG. 6a the circular disc 606 has a ringed edge 604 that makes contact with the rigid layer as described above. A middle part of the disc 606 may be shaped from thin near the center to thick near the edge. This will affect the transfer function from horizontal to vertical pressure displacement i.e. the further the force transfer lever 601 is pushed the more downward pressure will be delivered per unit of displacement.

In FIG. 6b the outer edge is implemented in a plurality of separated spokes 604 and is curved (viewed from the side) to facilitate sliding over the rigid layer (502 in FIG. 5a) when deforming under pressure. The center part of the disc 606 may be rigid or slightly flexible. However in FIG. 6b most of the deforming should be from the spokes 604.

One important aspect of this invention is that at the zero point (or neutral position) the friction between parts is minimal. For example, friction between the edge 604 (spokes) of the disc 606 and the rigid layer 502 (in FIG. 5) is maximum at maximum horizontal pressure, and minimal (almost zero) when there is no horizontal force.

FIG. 7 shows a simplified (compared to FIG. 6) implementation of a force sensing thumb stick. A mechanism with a single spring 712 is used in the center to provide the return to zero function and the force transfer mechanism. The spring 712 may be kept in position by retaining cups 715a and 715b although many alternative construction options are available—the key concept is that the single spring is used to transfer the horizontal force exerted by the user on a user interface lever 701 into vertical pressure onto the rigid layer 702 in a way that will also indicate the direction of the force. The spring 712 may also be formed using compressible material such as rubber or it may take the shape of a deformable disc as in FIG. 6.

The force transfer lever swivels/rotates around a ball bearing mechanism 716 and a rod 718 which is held by an outer housing (not shown). The rod 718 can also be used to press down on a push button switch not shown, but as per the switch 410 in FIG. 4.

As the force transfer lever 701 is pressed horizontally in any direction, force will be transferred via the spring 712 and the cup 715b onto the rigid layer 702. The magnitude of the force is measured by force sensors comprising interfering members 720 and coils 709 in the four corners of the layer 702.

The strength ratios between the spring 712 at the center and springs 713 at the four corners of the layer 702 will determine the ratio between the degree of movement of the force transfer lever 701 and the extent of the displacement of the interfering members 720 into the respective coils 709. The height of the pivot point at the mechanism 716 may also be adjusted to affect the force transfer action.

FIG. 8 shows an implementation of a joystick wherein a user interface lever 801 moves in a single plane (e.g. horizontally only) and not in a curved rotation-like movement as is found with most state of the art joysticks.

This can be done in many ways for example by the use of x-axis rails mounted on y-axis rails that will enable full x/y movement. There are examples of such joysticks in the art using resistive strips to determine the Cartesian position. However, in FIG. 8 a housing 808 is used to create a space 803 wherein a layer 804, that is attached to the user interface lever 801, can freely move in a single plane.

A pressure exerting member 802 is mounted such that it can slide across a surface of a rigid layer 809 in accordance with the movement caused by the user on the user interface lever 801. This will affect the movement of interfering members 807 into and out of respective inductor coils 806 in corners of the layer 809. The inductor coils 806 are connected to an inductive measurement IC (not shown but similar to the FIG. 2 arrangement) and this measurement information is used to determine the position of pressure as applied by the pressure exerting member 802.

Springs or other suitable components (not shown) are required to return the user interface lever 801 to a center or neutral position, when the user does not exert a force onto the user interface lever 801.

Software which interprets the inductive measurements can also be designed to offer calibration during manufacturing. For example, if the force vs displacement relationships for the four sensors (per this example) are not equal then a calibration step during manufacturing can be used to normalize the performance for minimum perceptional impact on the user. This will ease manufacturing constraints on the various parts.

Ideally differential inductive measurement information is used i.e. the information is determined from the change in measured inductance of more than one inductor at a time.

Since the member 802 slides over the surface of the layer 809 there will be wear and tear but with the right materials (e.g. glass, steel) for the layer 809 or even a ball bearing for the member 802, the lifetime can be very long compared to the life of a system wherein sliding contact over a resistive strip is established as per a rheostat implementation.

1. A method of operating a thumb stick arrangement which comprises a user interface force transfer lever, a rigid layer member and force sensors at spaced apart locations near the perimeter of the rigid layer member, each force sensor being responsive to displacement of the rigid layer member at the respective location, the method including the steps of using a mechanism to transfer a horizontal force applied by a user onto the force transfer lever into a vertical force which is applied onto the rigid layer member, determining measurements of the respective forces which are applied to the force sensors due to said vertical force, and using said force measurements from the sensors to calculate a metric which is related to the magnitude of the user applied horizontal force and a direction of application of the horizontal force.

2. The method of claim 1 wherein each force sensor is an inductive measurement sensor comprising at least one sensing inductor and at least one interfering member which is movable relative to the sensing inductor in response to said vertical force which is applied onto said rigid layer member.

3. The method of claim 2 wherein each said sensing inductor comprises a core, said interfering member being movable into the said core of said sensing inductor in response to said vertical force applied onto said rigid layer member, thereby to affect the measurable inductance of said sensing inductor.

4. The method of claim 2 which includes the steps of using the force sensors to distinguish between an in-touch condition and a no-touch condition by the user on the force transfer lever and of using the measurement of the no-touch condition for calibration of the respective force sensors and for correcting “stick drift” conditions.

5. The method of claim 1 wherein the thumb stick arrangement includes a magnet which is attached to said force transfer lever and a magnetic sensor which is responsive to movement of the magnet, said force transfer lever being rotatable when in a vertical position, and the method including the step of using the magnetic sensor information from said magnetic sensor to determine rotational information relating to said force transfer lever.

6. The method of claim 3 which includes the step of configuring the thumb stick arrangement so that the displacement of each said interfering member is less than one-fifth of the displacement of an upper end of said force transfer lever.

7. The method of claim 3 which includes the step of reporting displacement of the force transfer lever or the application of force thereto to the user using haptic signals.

8. A thumb stick arrangement which comprises a rigid layer member, a force transfer lever, a mechanism which is configured to transfer a horizontal force which is applied by a user onto the said force transfer lever into a vertical force which is applied onto the rigid layer member, a plurality of force sensors at spaced apart locations near the perimeter of the said rigid layer member, each respective sensor producing measurement information of the force applied to the respective force sensor due to said vertical force, and a mechanism for combining said measurement information to calculate a metric related to the magnitude of the user applied horizontal force and a direction of the horizontal force.

9. The thumb stick arrangement of claim 8 which includes a haptic signal generator, configured for user feedback, to indicate at least one of the magnitude of the horizontal force which is applied by the user on the force transfer lever, the end of movement range of the force transfer lever or a magnitude of vertical force applied to said force transfer lever.

10. The thumb stick arrangement in accordance with claim 8 wherein each force sensor is an inductive measurement sensor comprising a sensing inductor and at least one interfering member which is movable relative to the sensing inductor in response to said vertical force applied onto said rigid layer member.

11. The thumb stick arrangement of claim 10 wherein each sensing inductor comprises an inductor coil with a core and said interfering member is displaceable in response to said vertical force applied on said rigid layer member into the core of the said sensing inductor thereby to affect the measurable inductance of the said sensing inductor.

12. The thumb stick arrangement of claim 10 wherein the force sensors measurements are used to distinguish an in-touch condition and a no-touch condition by a user on the force transfer lever and wherein said mechanism uses information of a no-touch condition for calibration of said calculated metric and to avoid “stick drift”.

13. The thumb stick arrangement of claim 10 which includes a magnet which is attached to said force transfer lever and a magnetic field sensor which is responsive to rotational movement of the magnet and wherein said mechanism is configured to determine rotational movement of the force transfer lever using data from said magnetic field sensor.

14. The thumb stick arrangement of claim 10 wherein each inductive measurement sensor is configured so that displacement of the respective interfering member relative to said sensing inductor is less than one-fifth of the displacement of an upper end of said force transfer lever.
